(19) United States
(12) Patent Application Publication
(10) Pub. No.: US 2006/0032864 A1
(43) Pub. Date: Feb. 16, 2006

(54) Water dispenser

(76) Inventor: Suk Dong Jung, Seoul (KR)

Correspondence Address: APEX JURIS, PLLC, 13194 EDGEWATER LANE NORTHEAST, SEATTLE, WA, 98125, US

(21) Appl. No.: 11/165,630

(22) Filed: Jun. 23, 2005

(30) Foreign Application Priority Data
Aug. 16, 2004 (KR) 10-2004-0064145
Aug. 16, 2004 (KR) 10-2004-0064146

(51) Int. Cl. B67D 5/00

(52) U.S. Cl. 222/83

(57) ABSTRACT

A water dispenser is provided. The water dispenser includes: a main body for building-in a plurality of parts; a raw water tub provided at one side of the main body, for supplying raw water; an inlet pipe disposed at one side of the main body, for guiding and sucking the raw water from the raw water tub inside of the main body; and a shifter provided at one side of the inlet pipe, for shifting up and down the raw water tub or the inlet pipe to connect the raw water tub with the inlet pipe.

### BACKGROUND OF THE INVENTION

1. Field of the Invention

The present invention relates to a water dispenser, and more particularly, to a water dispenser configured to simply connect a raw water tub for supplying raw water, with an inlet pipe for guiding and introducing the raw water into a main body, using a shifter in a manual or automatic manner.

1. Description of the Related Art

In general, a water dispenser refers to a device for supplying cold water and hot water. Recently, due to the heavy pollution of water source resulting from an industrial waste water, raw water being on the market is being popularized instead of tap water, and the water dispenser for quickly cooling or heating the raw water is being used at a public place and an office and even at a home so that a user can have the cold water or the hot water.

FIG. 1 is a perspective view illustrating a conventional water dispenser with its front cover opened.

Referring to FIG. 1, the water dispenser includes a main body 10 shaped to have an approximately rectangular pillar; and a raw water tub 20 for supplying raw water. A take-out part 12 is provided at an upper side of a front part of the main body 10. The take-out part 12 includes a take-out cock 12a for controlling water discharged from the water dispenser; a gutter (not shown); and a gutter cover 12b.

A front cover 16 is provided at a lower side of the take-out part 12 to selectively open and close a tub housing part 14 for housing the raw water tub 20. The front cover 16 is formed of transparent material or is shaped to have a plurality of long holes 16a, thereby confirming a state of the raw water tub 20 housed in the tub housing part 14.

A tub mount 14a is provided at a lower side of the tub housing part 14. The tub mount 14a slidingly gets in and out of the tub housing part 14 to guide and place the raw water tub 20 in position. A handhold knob 14a′ is provided at a front and upper side of the tub mount 14a to facilitate the in/out of the tub mount 14a on which the raw water tub 20 is mounted.

An inlet unit 18 is provided at an upper side of the tub housing part 14 to suck the raw water from the raw water tub 20 inside of the main body 10. The inlet unit 18 includes an inlet hose 18a connected inside of the main body 10; a cap 18b connected to an upper spigot of the raw water tub 20; and an inlet conduit 18c inserted into the raw water tub 20.

The inlet conduit 18c serves to suck and transfer the raw water from the raw water tub 20 to a cold water tank (not shown) and a hot water tank (not shown) disposed inside of the main body 10. The inlet conduit 18c has a large length to facilitate withdrawal and replacement of the raw water tub 20 in the tub housing part 14. The cap 18b is connected at its upper side with the inlet hose 18a to seal the spigot of the raw water tub 20. The inlet conduit 18c is provided at a lower side of the cap 18b to facilitate water suction from the raw water tub 20.

Accordingly, when the raw water tub 20 is exhausted, the raw water tub 20 is withdrawn from the tub housing part 14 and disconnected from the cap 18b and the inlet conduit 18c of the inlet unit 18. After that, the raw water tub 20 is replaced and the cap 18b and the inlet conduit 18c are again connected in inverse order of disconnection.

However, the conventional water dispenser has the following drawbacks.

In other words, there is a drawback in that it takes a long time for replacement because the inlet unit 18 should be disconnected from the exhausted raw water tub 20 and connected with the filled one whenever the exhausted raw water tub 20 is replaced with the filled one.

There is a drawback in that it is not only hard for the user to replace the raw water tub 20, but also a foreign material is attached to the inlet conduit 18c, thereby causing poor sanitation because the inlet unit 18 is held with one hand while the exhausted raw water tub 20 being replaced with the other hand.

There is a drawback in that, due to a large length of the inlet hose 18a, when the raw water tub 20 is withdrawn from the tub housing part 14 and replaced with the new one, the inlet hose 18a is twisted, thereby causing a difficulty in supplying the raw water, and water stays and changes in quality in the inlet hose 18a.

### SUMMARY OF THE INVENTION

Accordingly, the present invention is directed to a water dispenser that substantially obviates one or more problems due to limitations and disadvantages of the related art.

An object of the present invention is to provide a water dispenser in which a raw water tub for supplying raw water is simply connected with an inlet pipe for guiding and introducing raw water into a main body, using a shifter in a manual or automatic manner.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a water dispenser, including: a main body for building-in a plurality of parts; a raw water tub provided at one side of the main body, for supplying raw water; an inlet pipe disposed at one side of the main body, for guiding and sucking the raw water from the raw water tub inside of the main body; and a shifter provided at one side of the inlet pipe, for shifting up and down the raw water tub or the inlet pipe to connect the raw water tub with the inlet pipe.

The raw water tub is a circular shaped water tub or a box shaped water tub.

An inlet guide is provided at one side the circular shaped water tub to guide water flow.

The inlet guide includes: an inlet conduit for sucking and guiding the raw water from the circular shaped water tub; and a fixing bracket for fixing the inlet conduit.

The box shaped water tub includes: a vinyl bag for housing the raw water; a sealing cap provided at one side of the vinyl bag, for controlling selective flow of the raw water; and a box for housing the vinyl bag and forming an exterior.

A guide is provided at one side of the inlet pipe to guide to place the circular shaped water tub or the box shaped water tub in exact position and concurrently, connect the inlet pipe with the fixing bracket or the sealing cap.

The guide has a fixing through-hole for housing and fixing the fixing bracket or the sealing cap.

An air groove is provided on one surface of the inlet conduit to guide and introduce external air inside of the circular shaped water tub.

The shifter is a lever assembly or a motor assembly.

The lever assembly includes: a lever shifter or a lever connector shifting up and down; a lever fixing unit for fixing and supporting the lever shifter or the lever connector; and a lever handle provided at one side of the lever shifter or the lever connector, for facilitating user's handhold.

The motor assembly includes: a motor for generating power; a pinion rotating by a driving force of the motor; and a rack shifting up and down depending on rotation of the pinion.

The present invention is advantageous of replacing the raw water tub more simply and conveniently, and supplying clean raw water without used water staying or remaining.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a conventional water dispenser with its front cover opened;

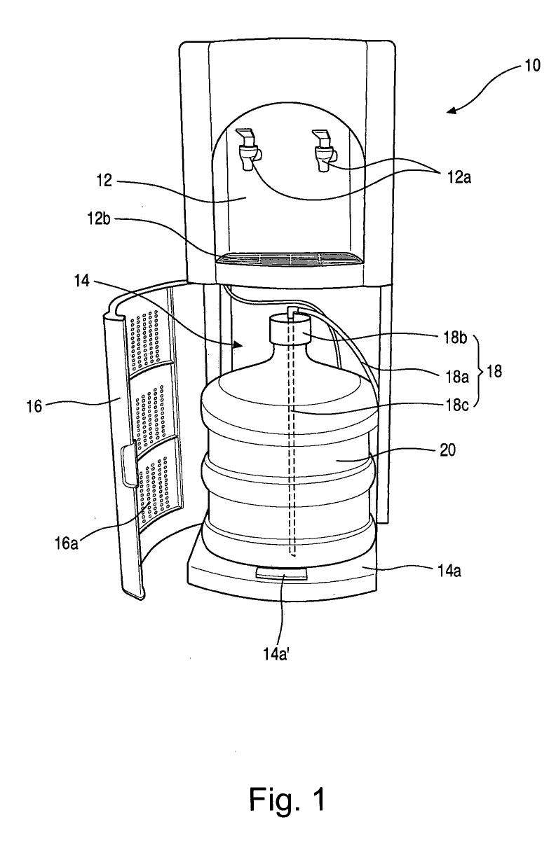

FIG. 2 is a perspective view illustrating a circular shaped water tub, and a main body of a water dispenser according to a preferred embodiment of the present invention;

FIG. 3 is a perspective view illustrating a box shaped water tub, and a main body of a water dispenser according to a preferred embodiment of the present invention;

FIG. 4A is a partial sectional view illustrating a water dispenser where an inlet pipe having a sealing member is shifted downward and connected with an inlet guide according to a preferred embodiment of the present invention;

FIG. 4B is a partial sectional view illustrating a water dispenser where an inlet pipe is shifted downward and connected with an inlet guide having a sealing member according to a preferred embodiment of the present invention;

FIG. 4C is a partial sectional view illustrating a water dispenser where an inlet pipe having a sealing member is shifted downward and connected with a sealing cap according to a preferred embodiment of the present invention;

FIG. 5A is a partial side view illustrating a water dispenser where an inlet pipe is connected with an inlet guide in a manual manner using a shifter of a lever assembly according to a preferred embodiment of the present invention;

FIG. 5B is a partial front view illustrating a water dispenser where an inlet pipe is connected with an inlet guide in a manual manner using a shifter of a lever assembly according to a preferred embodiment of the present invention;

FIG. 6A is a partial side view illustrating a water dispenser where an inlet pipe is connected with a sealing cap in a manual manner using a shifter of a lever assembly according to a preferred embodiment of the present invention;

FIG. 6B is a partial front view illustrating a water dispenser where an inlet pipe is connected with a sealing cap in a manual manner using a shifter of a lever assembly according to a preferred embodiment of the present invention;

FIG. 7 is a partial front view illustrating another embodiment of FIG. 5B;

FIG. 8 is a partial front view illustrating another embodiment of FIG. 6B;

FIG. 9 is a partial front view illustrating a water dispenser where a circular shaped water tub is connected with an inlet pipe in a manual manner using a shifter of a lever assembly according to a preferred embodiment of the present invention;

FIG. 10 is a partial front view illustrating a water dispenser where a box shaped water tub is connected with an inlet pipe in a manual manner using a shifter of a lever assembly according to a preferred embodiment of the present invention;

FIG. 11A is a partial front view illustrating a water dispenser where an inlet pipe is connected with an inlet guide in an automatic manner using a shifter of a motor assembly according to a preferred embodiment of the present invention;

FIG. 11B is a partial front view illustrating a water dispenser where a circular shaped water tub is connected with an inlet pipe in an automatic manner using a shifter of a motor assembly according to a preferred embodiment of the present invention;

FIG. 12A is a partial front view illustrating a water dispenser where an inlet pipe is connected with a sealing cap in an automatic manner using a shifter of a motor assembly according to a preferred embodiment of the present invention; and

FIG. 12B is a partial front view illustrating a water dispenser where a box shaped water tub is connected with an inlet pipe in an automatic manner using a shifter of a motor assembly according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

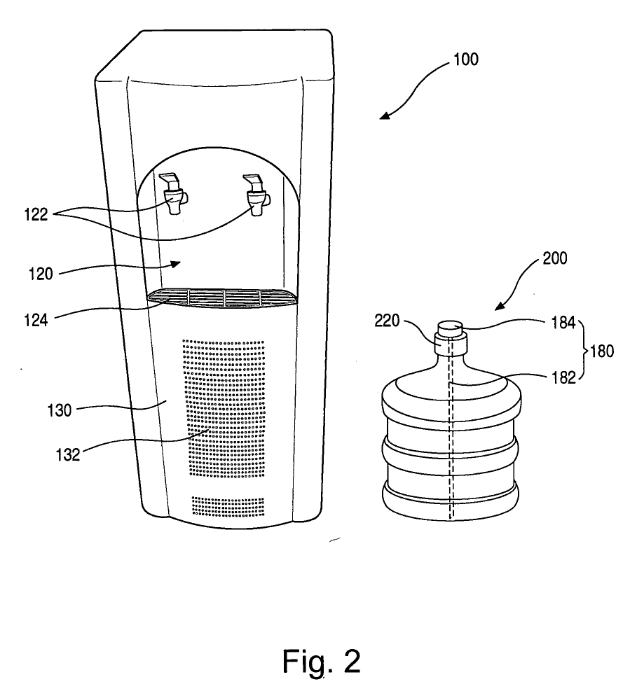

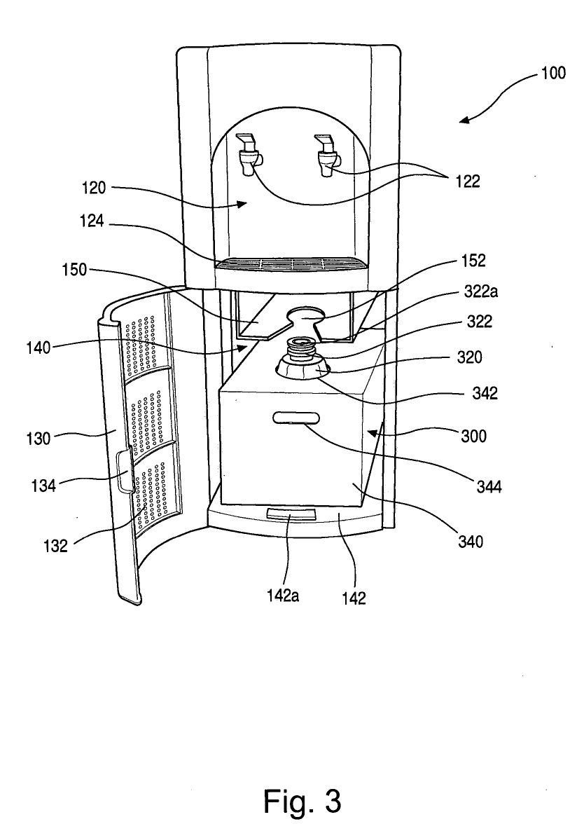

FIG. 2 is a perspective view illustrating a circular shaped water tub, and a main body of a water dispenser according to a preferred embodiment of the present invention, and FIG. 3 is a perspective view illustrating a box shaped water tub, and a main body of a water dispenser according to a preferred embodiment of the present invention.

Referring to FIGS. 2 and 3, the inventive water dispenser includes a main body 100 shaped to have a rectangular parallelepiped whose length is approximately larger than a width, and building-in a plurality of parts; and a circular shaped water tub 200 or a box shaped water tub 300 provided at a lower side and inside of the main body 100 to supply raw water.

A take-out part 120 is provided at an upper side of a front part of the main body 100 to take out the raw water from the circular shaped water tub 200 or the box shaped water tub 300. A take-out cock 122 is protrusively provided at the take-out part 120 to regulate water discharged from the water dispenser. A gutter (not shown) is provided at a lower side of the take-out cock 122, and a gutter cover 124 is provided at an upper side of the gutter. A front cover 130 is installed at a lower side of the take-out part 120 to selectively open and close a tub housing part 140 for housing the circular shaped water tub 200 or the box shaped water tub 300.

It is desirable that the front cover 130 is formed of transparent material or is shaped to have a long hole 132, thereby confirming a state of the circular shaped water tub 200 or the box shaped water tub 300 housed in the tub housing part 140. A cover knob 134 is provided at a lateral and central portion of the front cover 130 to facilitate user's handhold for opening and closing.

A tub mount 142 is provided at a lower side of the tub housing part 140. The tub mount 142 slidingly gets in and out of the tub housing part 140 to guide and place the circular water rub 200 or the box shaped water tub 300 in position. A mount knob 142a is provided at a front and upper side of the tub mount 142 to facilitate user's handhold and the in/out of the tub mount 142 on which the circular shaped water tub 200 or the box shaped water tub 300 is mounted.

The circular shaped water tub 200 or the box shaped water tub 300 holding the raw water is mounted on the tub mount 142. The circular shaped water tub 200 includes a tub cap 220 for preventing arbitrary water leakage at its upper end; and an inlet guide 180 connected with the inlet pipe 160 (described below) for guiding water flow. The box shaped water tub 300 includes a vinyl bag 320 for housing the raw water, and a box 340 for housing the vinyl bag 320 and forming an exterior.

The inlet guide 180 provided at an upper end of the circular shaped water tub 200 includes an inlet conduit 182 inserted into the circular shaped water tub 200; and a fixing bracket 184 provided integrally with or separately from the inlet conduit 182, and fixed to the upper end of the circular shaped water tub 200, that is, to a spigot of the circular shaped water tub 200.

It is desirable that the inlet conduit 182 is provided as long as possible so that it reaches an inner bottom of the circular shaped water tub 200 to suck the raw water from the circular shaped water tub 200. It is more desirable that the inlet conduit 182 is formed of rigid plastic, and has a slanting end to facilitate its passage through the tub cap 220.

An air groove 182a is provided on one surface of the inlet conduit 182 connected with the tub cap 220, to introduce external air, thereby allowing smooth suction of the raw water from the circular shaped water tub 200.

A sealing cap 322 is connected with the inlet pipe 160 (described below) at an upper side of the vinyl bag 320 of the box shaped water tub 300, to control a selective outflow of raw water. The sealing cap 322 is shaped to have an approximately circular shape. The sealing cap 322 has an inlet port 322a at its center to allow the inlet pipe 160 to connect with the sealing cap 322 through the inlet port 322a. The sealing cap 322 has a guide groove 322′ at its circumferential surface to allow its fixation to a guide 150 (described below).

The box 340 is shaped to have an approximately rectangular tub shape, thereby housing the vinyl bag 320, and is formed of a light-weighting paper material. The box 340 has an opening part 342 on its upper surface to allow the in/out of the sealing cap 322 for discharging the raw water. The box 340 has a box knob 344 on its both lateral surfaces to facilitate user's handhold and shift of the box shaped water tub 300.

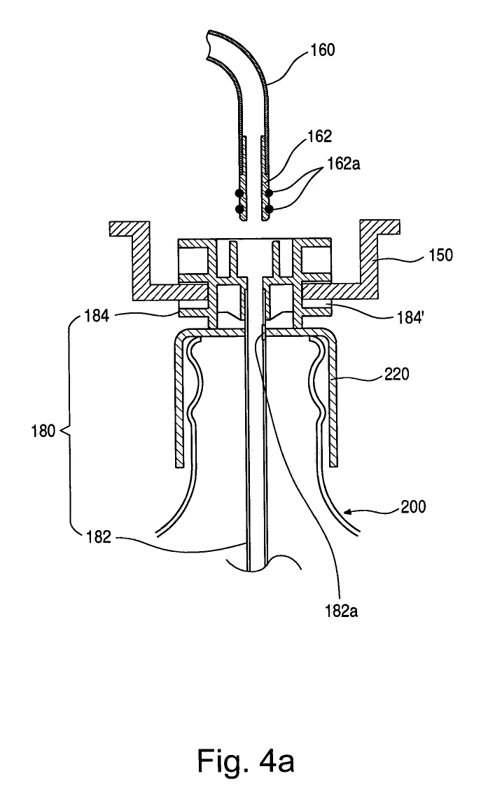

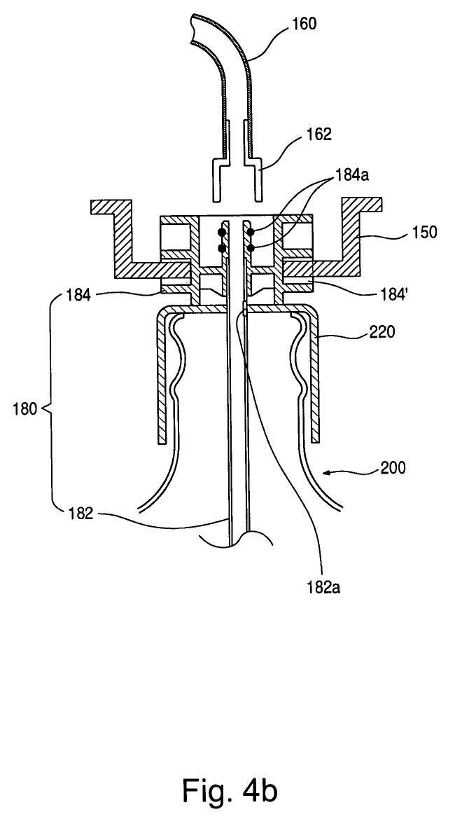

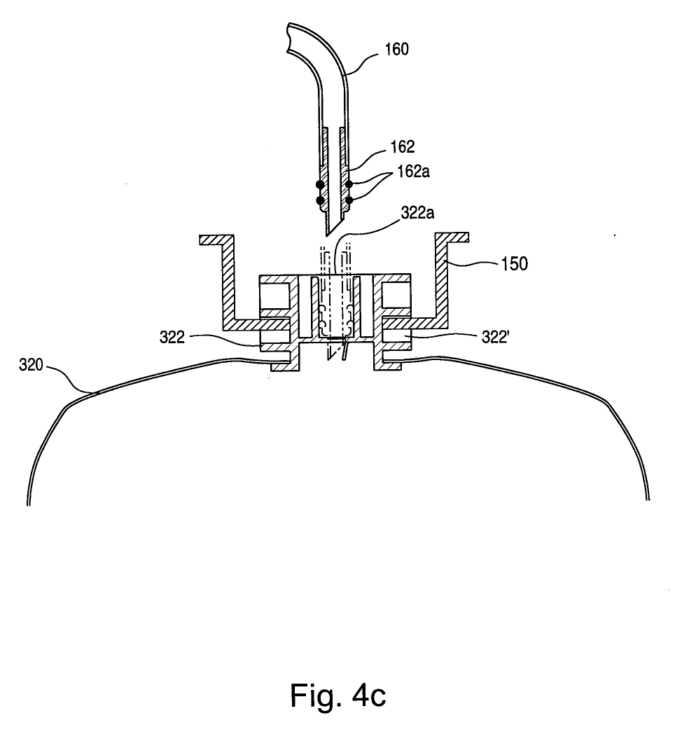

FIG. 4A is a partial sectional view illustrating a water dispenser where an inlet pipe having a sealing member is shifted downward and connected with an inlet guide according to a preferred embodiment of the present invention. FIG. 4B is a partial sectional view illustrating a water dispenser where an inlet pipe is shifted downward and connected with an inlet guide having a sealing member according to a preferred embodiment of the present invention. FIG. 4C is a partial sectional view illustrating a water dispenser where an inlet pipe is shifted downward and connected with a sealing cap according to a preferred embodiment of the present invention.

Referring to FIGS. 4A to 4C, the inlet pipe 160 is installed at an upper side of the tub housing part 140 to suck the raw water from the circular shaped water tub 200 or the box shaped water tub 300. The inlet pipe 160 sucks the raw water from the circular shaped water tub 200 or the box shaped water tub 300, toward a cold water tank (not shown) and a hot water tank (not shown) of the main body 100.

Accordingly, the sucked raw water is temporarily stored in the cold water tank and the hot water tank through the inlet pipe 160, and the stored raw water is discharged through the take-out cock 122 of the take-out part 120 for user's drinking purpose.

The guide 150 is provided at one side of the inlet pipe 160 to guide and place the circular shaped water tub 200 or the box shaped water tub 300 in exact position and concurrently, to guide and connect the inlet pipe 160 with the fixing bracket 184 or the sealing cap 322.

The guide 150 is shaped to have an approximately rectangular tub shape. A fixing through-hole 152 is provided at a front portion of the guide 150 to house and fix the fixing bracket 184 or the sealing cap 322.

The fixing through-hole 152 has a depression shape from its front to the rear. In more detail, it is desirable that the fixing through-hole 152 is shaped to be more narrowed as going to the rear such that the fixing bracket 184 or the sealing cap 322 enters a wider front space of the fixing through-hole 152 and is fixed in a narrower rear space, and concurrently the fixing through-hole 152 is shaped to facilitate guiding and connecting its circumferential surface with a guide groove 184′ or 322′ provided on a circumferential surface of the fixing bracket 184 or the sealing cap 322.

A connection member 162 is provided at a lower end of the inlet pipe 160, and is directly connected with the fixing bracket 184 or the sealing cap 322. The connection member 162 is formed of injection or metal material, and is connected with a lower and inner end of the inlet pipe 160.

As shown in FIG. 4C, a connection member 162 is sharpened at its end to allow its passage through the sealing cap 322. In more detail, the connection member 162 has a slanting and sharp section at its end to facilitate its passage through the inlet pipe 322a disposed at the central of the sealing cap 322.

A sealing member 162a is provided at a lower and outer end of the connection member 162 to prevent a motion of the inlet pipe 160 inserted into the fixing bracket 184 or the sealing cap 322 and concurrently, to prevent external air from being sucked when the raw water is sucked from the circular shaped water tub 200 or the box shaped water tub 300.

It is desirable that the sealing member 162a is ring-shaped and formed of rubber material. The sealing member 162a is fitted at a lower end of the connection member 162 and connected inside of the fixing bracket 184 or the sealing cap 322, to seal the inlet pipe 160 against the inlet guide 180 or the sealing cap 322.

In contrast to the fact that the connection member 162 of the inlet pipe 160 is connected inside of the fixing bracket 184 of the inlet guide 180, as shown in FIG. 4B, the fixing bracket 184 having a predetermined protrusion formed therein is inserted into and connected with the connection member 162 using the sealing member 184a.

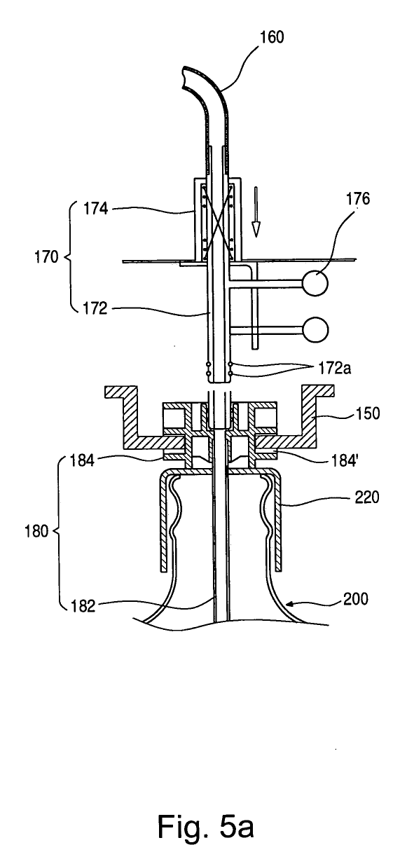

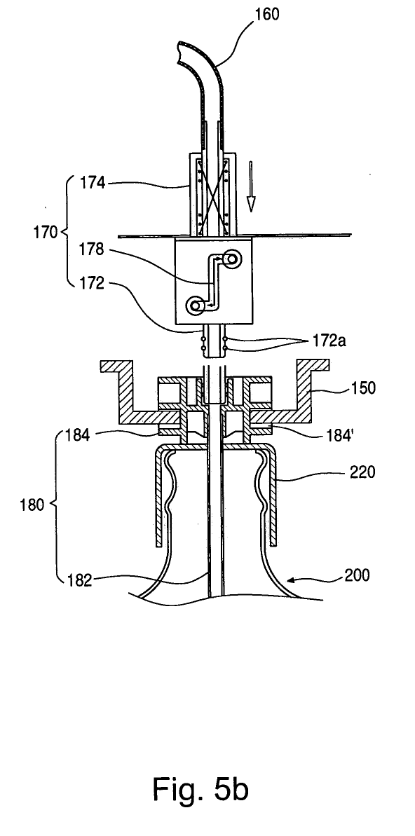

FIGS. 5A and 5B are a partial side view and a partial front view illustrating the water dispenser where the inlet pipe is connected with the inlet guide in the manual manner, using the shifter of the lever assembly according to a preferred embodiment of the present invention.

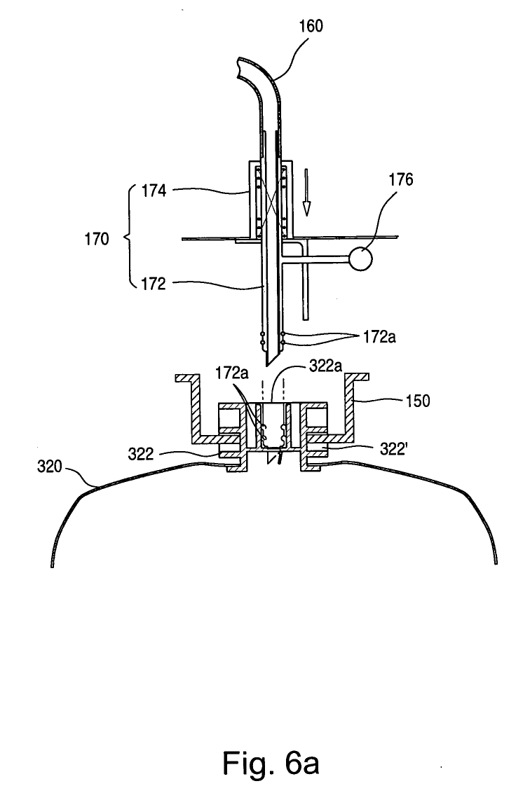

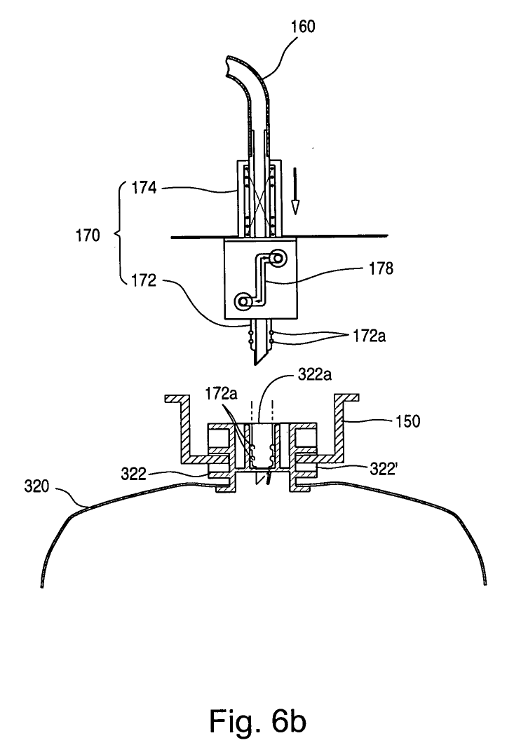

FIGS. 6A and 6B are a partial side view and a partial front view illustrating the water dispenser where the inlet pipe is connected with the sealing cap in the manual manner, using the shifter of the lever assembly according to a preferred embodiment of the present invention.

Referring to the drawings, the inlet pipe 160 is connected with and the inlet guide 180 or the sealing cap 322, using the lever assembly 170.

The lever assembly 170 includes a lever shifter 172 inserted into the fixing bracket 184 or the sealing cap 322; a lever fixing unit 174 for fixing and supporting the lever shifter 172; a lever handle provided at one side of the lever shifter 172 to allow user's handhold; and a lever guide 178 provided at a lower side of the lever fixing unit 174.

The lever shifter 172 is formed integrally with lever handle 176. Accordingly, when the user holds and pulls down the lever handle 176, the lever shifter 172 is directly shifted downward and is connected to the fixing bracket 184 or the sealing cap 322. The lever shifter 172 further includes a sealing member 172a at its outer end such that it is completely sealed and connected to the fixing bracket 184 or the sealing cap 322.

The lever fixing unit 174 is connected to an end of the inlet pipe 160, to support the lever shifter 172 shifting upward or downward. The lever guide 178 is provided at a lower side of the lever fixing unit 174, to guide up/down shift of the lever handle 176.

The lever guide 178 is shaped to have an approximately curved ‘S’-shape. This ‘S’-shape is to insert and fix the lever handle 176 to up/down curved portions of the lever guide 178 when the lever handle 176 is to be shifted downward or upward and then stopped.

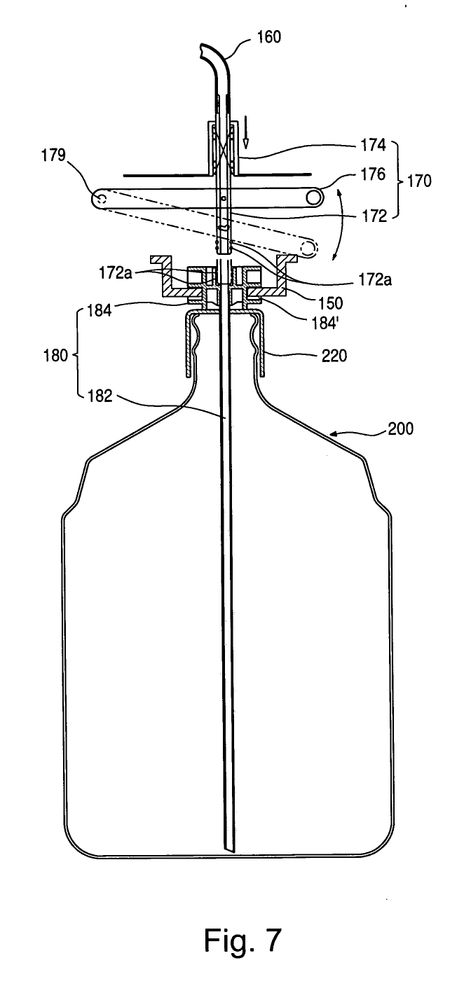

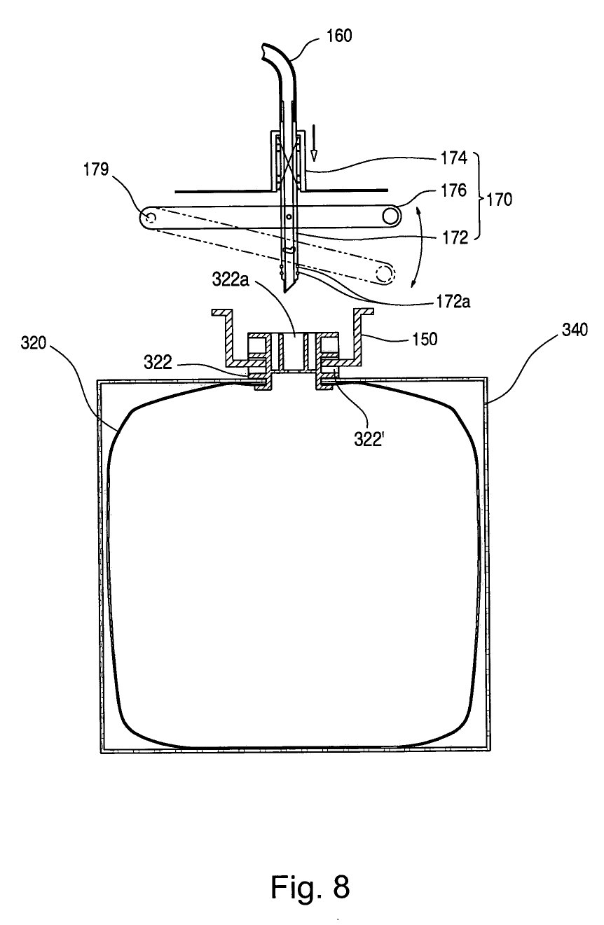

FIG. 7 is a partial front view illustrating another embodiment of FIG. 5B, and FIG. 8 is a partial front view illustrating another embodiment of FIG. 6B.

As shown in FIGS. 7 and 8, the lever handle 176 is fixed at its one end to the main body 100 using a hinge 179 to allow the lever shifter 172 to shift up/down, thereby connecting the lever assembly 170 with the inlet pipe 160 and the inlet guide 172 or the sealing cap 322.

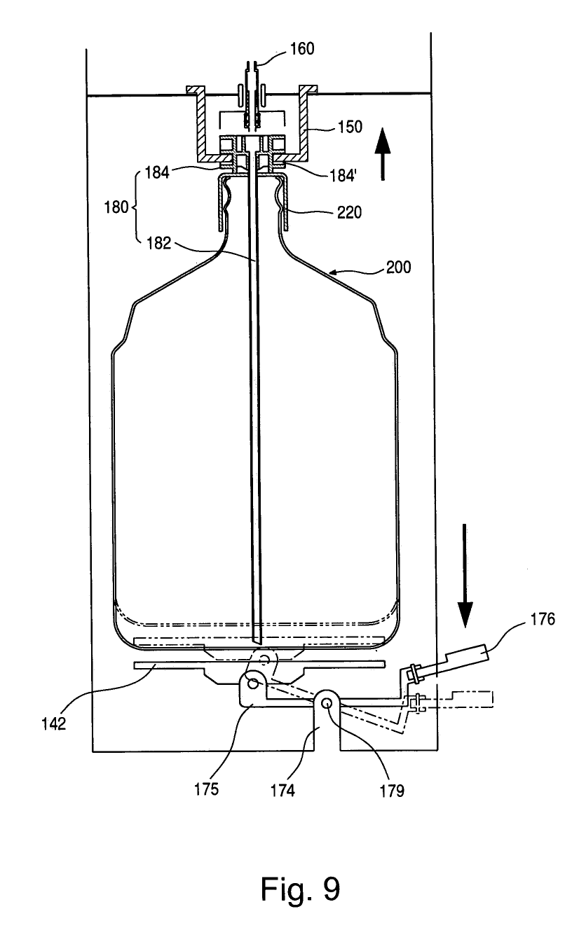

FIG. 9 is a partial front view illustrating the water dispenser where the circular shaped water tub is connected with the inlet pipe in the manual manner, using the shifter of the lever assembly according to a preferred embodiment of the present invention.

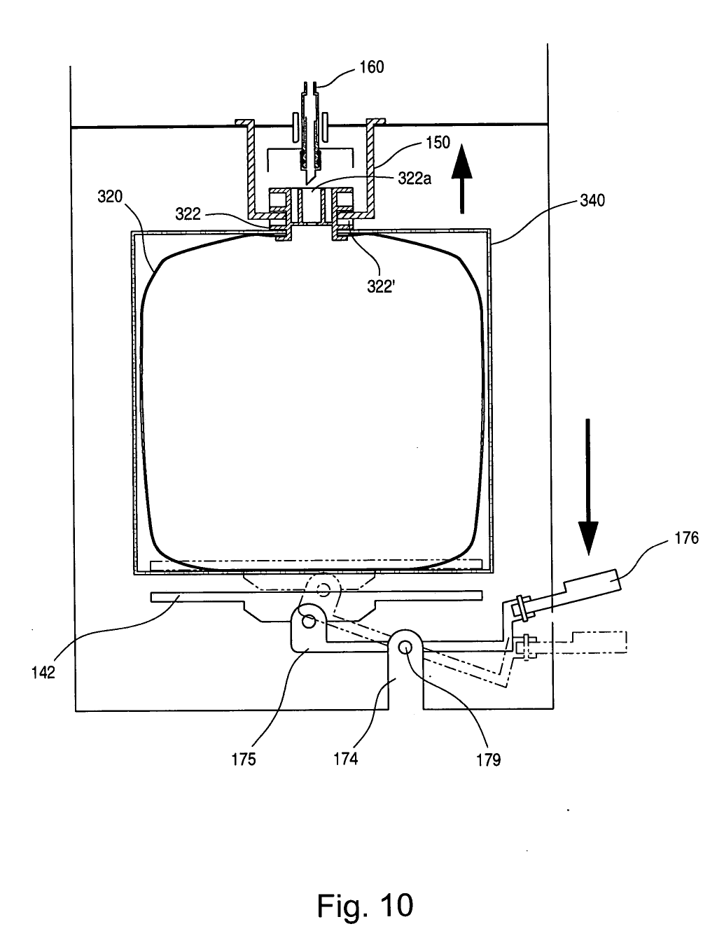

FIG. 10 is a partial front view illustrating the water dispenser where the box shaped water tub is connected with the inlet pipe in the manual manner, using the shifter of the lever assembly according to a preferred embodiment of the present invention.

Referring to FIGS. 9 and 10, the inlet pipe 160 is fixed inside of the main body 100, and the water tub mount 142 for mounting the circular shaped water tub 200 or the box shaped water tub 300 is shifted upward by the lever assembly 170. Accordingly, the inlet pipe 160 is connected with the circular shaped water tub 200 or the box shaped water tub 300.

A lever connector 175 is provided down of the tub mount 142. The lever connector 175 is connected at its one end with the lever handle 176, and is connected at the other end with a lower and central portion of the tub mount 142 to support the tub mount 142. The lever connector 175 is connected at its central portion to the lever fixing unit 174 fixed to the lower portion of the tub mount 142, using the hinge 179.

Accordingly, if the lever handle 176 is forced downward, a lever connector 175 portion connected with the tub mount 142 is shifted upward about a central portion of the lever connector 175 to shift upward the circular shaped water tub 200 or the box shaped water tub 300. As a result, the inlet pipe 160 is connected with the inlet guide 180 or the sealing cap 322 respectively provided at the circular shaped water tub 200 or the box shaped water tub 300.

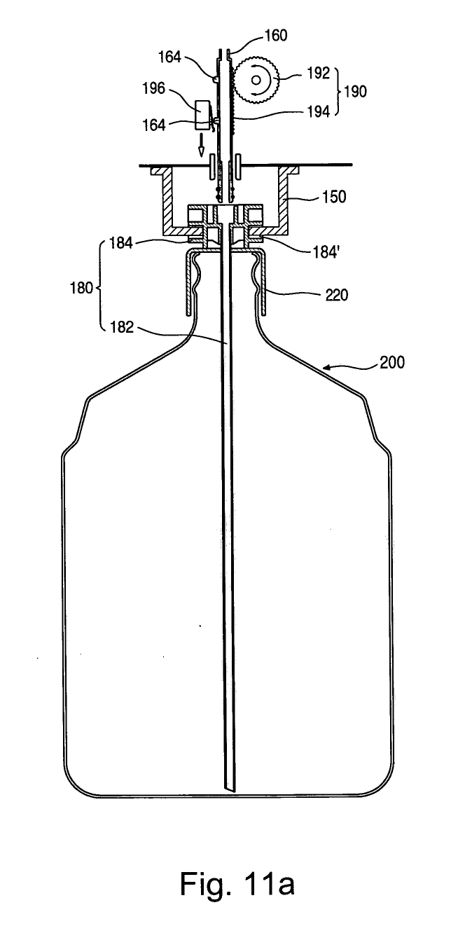

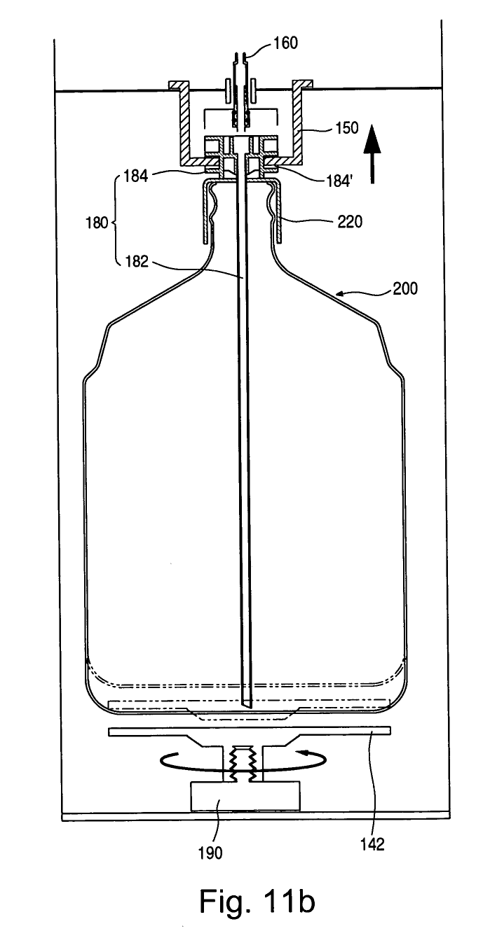

FIG. 11A is a partial front view illustrating the water dispenser where the inlet pipe is connected with the inlet guide in an automatic manner, using a shifter of a motor assembly according to a preferred embodiment of the present invention.

FIG. 11B is a partial front view illustrating the water dispenser where the circular shaped water tub is connected with the inlet pipe in the automatic manner, using the shifter of the motor assembly according to a preferred embodiment of the present invention.

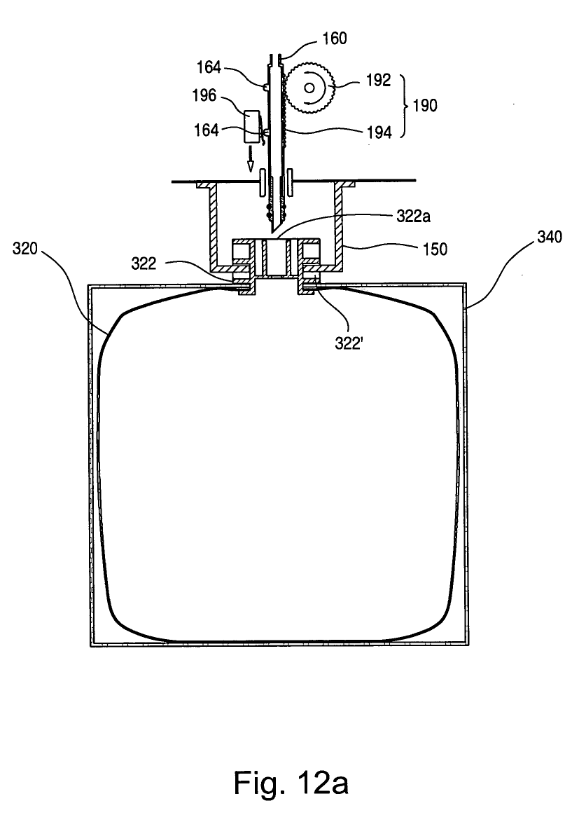

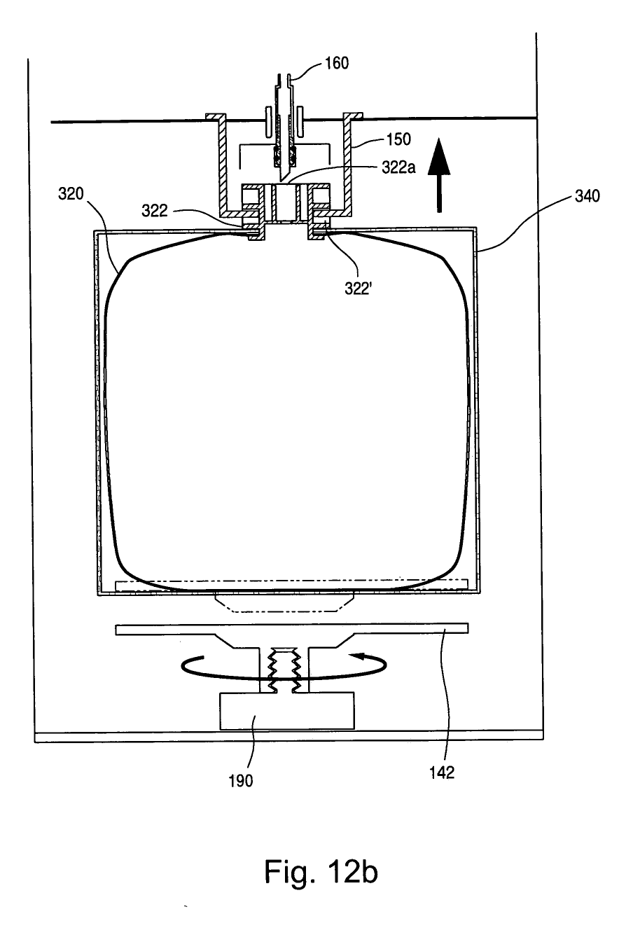

FIG. 12A is a partial front view illustrating the water dispenser where the inlet pipe is connected with the sealing cap in the automatic manner, using the shifter of the motor assembly according to a preferred embodiment of the present invention.

FIG. 12B is a partial front view illustrating the water dispenser where the box shaped water tub is connected with the inlet pipe in the automatic manner, using the shifter of the motor assembly according to a preferred embodiment of the present invention.

Referring to the drawings, the motor assembly 190 includes a motor (not shown) for generating power; a pinion 192 rotating by a driving force of the motor; and a rack 194 geared with the pinion 192 to shift up/down depending on rotation of the pinion 192. The rack 194 is long formed up to down on a right surface of the inlet pipe 160, and two contact protrusions 164 are spaced apart up and down on a left surface of the inlet pipe 160. A micro-switch 196 connecting with the motor is configured to be in contact with the contact protrusions 164.

Accordingly, if the pinion 192 is rotated by the driving force of the motor, the inlet pipe 160 having the rack 194 engaged with the pinion 192 is shifted up and down, and the contact protrusion 164 contacts the micro-switch 196 due to the up/down shift of the inlet pipe 160, thereby controlling a motor operation of the motor assembly 190.

As shown in FIG. 11A or 12A, the motor assembly 190 is disposed at one side of the inlet pipe 160 to shift up and down the inlet pipe 160. Or, as shown in FIG. 11B or 12B, the motor assembly 190 is disposed at a lower side of the circular shaped water tub 200 or the box shaped water tub 300 to shift up and down the circular shaped water tub 200 or the box shaped water tub 300, thereby connecting the inlet pipe 160 with the inlet guide 180 of the circular shaped water tub 200 or the sealing cap 322 of the box shaped water tub 300.

The motor assembly 190 can be configured to automatically shift up and down the inlet pipe 160 or to shift up and down the inlet guide 180 or the sealing cap 322, using a controller (not shown) disposed at one side of the main body 100 and a front cover sensor (not shown) disposed at one side of the main body 100 and the front cover 130.

Shift operations of the inlet pipe 160 and the inlet guide 180 or the sealing cap 322 using the motor assembly 190 will be briefly described as follows.

If the front cover 130 disposed at the front and lower side of the main body 100 is closed, a front cover switch (not shown) is switched on and a switch-on signal is applied to the controller through the front cover sensor (not shown), and the controller confirms a current position of the inlet pipe 160 through a inlet pipe position sensor (not shown).

When the inlet pipe 160 is not in contact with the inlet guide 180 or the sealing cap 322, that is, when the inlet guide 180 or the sealing cap 322 is in contact with a lower one of two contact protrusions 164 (that is, high in position), a motor driver (not shown) drives the motor in a forward direction to shift the inlet pipe 160 inside of the fixing bracket 184 of the inlet guide 180 or inside of the sealing cap 322, thereby connecting the inlet pipe 160 with the fixing bracket 184 or the sealing cap 322 and making it possible to suck the raw water.

Even when the motor is driven in the forward direction for a predetermined time to shift downward the inlet pipe 160, if the inlet pipe 160 is not shifted inside of the fixing bracket 184 or the sealing cap 322, that is, if the inlet pipe 160 is high in position, the motor stops and error beep sounds to lead the user to check a state of the water dispenser.

When the front cover 130 is opened, the front cover switch is switched off, and the controller enables the motor in a reverse direction to disconnect the inlet pipe 160 from the fixing bracket 184 or the sealing cap 322, thereby shifting upward the inlet pipe 160, and to allow the micro switch 196 to be in contact with the upper contact protrusion 164 of the inlet pipe 160, thereby stopping shifting upward the inlet pipe 160.

Even when the motor is driven in the reverse direction for a predetermined time, if the inlet pipe 160 is still connected with the fixing bracket 184 or the sealing cap 322, that is, if the inlet pipe 160 is low in position, the motor stops and the error beep sounds to lead the user to check the state of the water dispenser.

As described above, in the inventive water dispenser, the guide is provided at one side of the tub housing part for housing the circular shaped water tub or the box shaped water tub, to guide and fix the inlet guide of the circular shaped water tub or the sealing cap of the box shaped water tub, thereby connecting the inlet pipe with the inlet guide or the sealing cap with the shifter having the manual-type lever assembly or the automatic-type motor assembly.

Accordingly, the inventive water dispenser provides an effect of reducing a replacement time for the exhausted raw water tub, by easily, simply and conveniently withdrawing and replacing the raw water tub and reconnecting a filled raw water tub in the water dispenser.

The inventive water dispenser provides an effect of improving convenience in use, by replacing the raw water tub and connecting the inlet pipe with the inlet guide or the sealing cap in the manual manner of one-time lever operation or in the automatic manner using the motor.

The inventive water dispenser provides an effect of preventing sanitary concern in use due to water deterioration or bacteria propagation, which is caused when water always stays in a long inlet hose of a conventional water dispenser, by shortening a length of the inlet pipe connected inside of the main body.

As a result, the inventive water dispenser provides an effect of improving a reliability of product and increasing the amount of product recognition, thereby increasing a desire for product purchase, by securing convenience in use and water safety.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A water dispenser, comprising:
a main body for building-in a plurality of parts;
a raw water tub provided at one side of the main body, for supplying raw water;
an inlet pipe disposed at one side of the main body, for guiding and sucking the raw water from the raw water tub inside of the main body; and
a shifter provided at one side of the inlet pipe, for shifting up and down the raw water tub or the inlet pipe to connect the raw water tub with the inlet pipe.

2. The water dispenser according to claim 1, wherein the raw water tub is a circular shaped water tub or a box shaped water tub.

3. The water dispenser according to claim 2, wherein an inlet guide is provided at one side the circular shaped water tub to guide water flow.

4. The water dispenser according to claim 3, wherein the inlet guide comprises:
an inlet conduit for sucking and guiding the raw water from the circular shaped water tub; and
a fixing bracket for fixing the inlet conduit.

5. The water dispenser according to claim 2, wherein the box shaped water tub comprises:
a vinyl bag for housing the raw water;
a sealing cap provided at one side of the vinyl bag, for controlling selective flow of the raw water; and
a box for housing the vinyl bag and forming an exterior.

6. The water dispenser according to claim 4 or 5, wherein a guide is provided at one side of the inlet pipe to guide to place the circular shaped water tub or the box shaped water tub in exact position and concurrently, connect the inlet pipe with the fixing bracket or the sealing cap.

7. The water dispenser according to claim 6, wherein the guide has a fixing through-hole for housing and fixing the fixing bracket or the sealing cap.

8. The water dispenser according to claim 4, wherein an air groove is provided on one surface of the inlet conduit to guide and introduce external air inside of the circular shaped water tub.

9. The water dispenser according to claim 1, wherein the shifter is a lever assembly or a motor assembly.

10. The water dispenser according to claim 9, wherein the lever assembly comprises:
a lever shifter or a lever connector shifting up and down;
a lever fixing unit for fixing and supporting the lever shifter or the lever connector; and
a lever handle provided at one side of the lever shifter or the lever connector, for facilitating user's handhold.

11. The water dispenser according to claim 9, wherein the motor assembly comprises:
a motor for generating power;
a pinion rotating by a driving force of the motor; and
a rack shifting up and down depending on rotation of the pinion.
